(19) United States
(12) Patent Application Publication
(10) Pub. No.: US 2022/0356623 A1
(43) Pub. Date: Nov. 10, 2022

(54) Method And Apparatus For Transferring Process Air In A Combo Washer/Dryer Unit

(71) Applicant: Whirlpool Corporation, Benton Harbor, MI (US)

(72) Inventors: Arun Rajendran, St. Joseph, MI (US); Jason R. Spears, St. Joseph, MI (US)

(21) Appl. No.: 17/307,136

(22) Filed: May 4, 2021

(51) Int. Cl. D06F 25/00; D06F 58/20; F26B 21/00

(52) U.S. Cl. CPC D06F 25/00; D06F 58/20; F26B 21/004

(57) ABSTRACT

A mechanism for transferring processed air in an appliance, such as a dryer or washer/dryer combination or the like, between a tub assembly and an exhaust housing has a flexible duct with an inlet end and an outlet end. The inlet end connects to the tub/drum assembly and the outlet end connects to the exhaust housing. A compressing and expanding member is positioned between the inlet end and the outlet end. The mechanism compressing and/or expanding with movement of the tub/drum assembly during washing and/or drying cycles. At least one of the inlet and outlet ends includes a retaining member to secure the duct with the tub/drum assembly or the exhaust housing.

### FIELD

The present disclosure relates to laundry and, more particularly, to combination washers/dryers with a device for transferring process air during operation.

### BACKGROUND

In washer/dryer combo units, it is difficult to transfer the processed air from the drum to the outside via a lint trap during the drying operation. Generally, a duct between the tub and lint housing does not compensate for the movement of the dynamic tub/drum assembly connected to a static exhaust housing. Thus, it has been difficult to provide a smooth transition of the airflow from the tub/drum assembly to the exhaust assembly. The duct work has been static and does not provide for the compressive and expansive movements needed during the washing and drying cycles.

Accordingly, it is an object of the present disclosure to provide a flexible duct that enables a smooth transition of drying air from the dynamic tub/drum assembly to the exhaust housing. The present disclosure accounts for vibration and movement of the tub/drum assembly during the washing and drying cycles. The present disclosure provides a duct that compresses and expands during the movement of the tub/drum assembly during the washing and drying cycles. The present disclosure provides a positive connection between the tub and the exhaust housing.

### SUMMARY

According to the present disclosure, a mechanism for transferring processed air in an appliance, such as a washer/dryer combination or the like, between a tub/drum assembly and an exhaust housing comprises a flexible duct with an inlet end and an outlet end. The inlet end connects to the tub/drum assembly and the outlet end connects to the exhaust housing. A compressive and expansive mechanism is positioned between the inlet and the outlet ends. The mechanism compresses and expands with movement of the tub/drum assembly during washing and drying cycles of the appliance. At least one of the inlet end and outlet end includes a retaining member to secure the duct with the tub/drum assembly or the exhaust housing. The compressing and expanding mechanism includes at least one bellows in the duct to enable movement of the duct in response to tub/drum assembly movement. The bellows is positioned adjacent the outlet end. The retainer member may be a tongue and groove assembly securing at least the outlet end. The tongue and groove assembly is placed at both the inlet and outlet ends. The inlet end tongue and groove assembly includes an annular collar with peaks and valleys meshing with corresponding peaks and valleys in the duct inlet. The annular collar is to be secured to the tub assembly. The outlet end tongue and groove assembly includes a flange on the exhaust housing with peaks and valleys meshing with corresponding peaks and valleys in the duct outlet. Alternatively, the duct may be a two piece design with a duct portion and a bellows secured to the duct portion in the exhaust housing. The duct portion includes two halves secured with one another and a connection member secured with a collar to secure the duct portion to the tub. The duct portion includes a receiving portion for receiving the compressing and expanding member and a clamp for maintaining the compressing/expanding member on the duct portion.

According to a second embodiment of the disclosure, a combination washer/dryer comprises a housing cabinet with a tub/drum assembly positioned inside. The tub/drum assembly includes an exhaust outlet. A flexible duct includes an inlet end and an outlet end. The inlet end connects to the tub assembly and the outlet end connects to an exhaust housing. A compressive and expansive mechanism is positioned between the inlet and the outlet ends. The mechanism compresses and expands with movement of the tub/drum assembly during washing and drying cycles of the appliance. At least one of the inlet end and outlet end includes a retaining member to secure the duct with the tub/drum assembly or the exhaust housing. The compressing and expanding mechanism includes at least one bellows in the duct to enable movement of the duct in response to tub/drum assembly movement. The bellows is positioned adjacent the outlet end. The retainer member may be a tongue and groove assembly securing at least the outlet end. The tongue and groove assembly is placed at both the inlet and outlet ends. The inlet end tongue and groove assembly includes an annular collar with peaks and valleys meshing with corresponding peaks and valleys in the duct inlet. The annular collar secured to the tub/drum assembly. The outlet end tongue and groove assembly includes a flange on the exhaust housing with peaks and valleys meshing with corresponding peaks and valleys in the duct outlet. Alternatively, the duct may be a two piece design with a duct portion and a bellows secured to the duct portion in the exhaust housing. The duct portion includes two halves secured with one another and a connection member secured with a collar to secure the duct portion to the tub. The duct portion includes a receiving portion for receiving the compressing and expanding member and a clamp for maintaining the compressing/expanding member on the duct portion.

According to a third aspect of the disclosure, a method of transferring processed air in a combo washer/dryer unit comprises providing a housing unit or cabinet. A tub/drum assembly is positioned inside a housing unit. The tub assembly includes an exhaust outlet. A flexible duct has an inlet end and an outlet end. The inlet end connects to the tub/drum assembly and the outlet end connects to an exhaust housing. A compressing and expanding member is positioned between the inlet end and the outlet end. The mechanism compresses and expands with movement of the tub/drum assembly during washing and/or drying cycles of the appliance. At least one of the inlet and outlet ends includes a retaining member to secure the duct with the tub assembly or the exhaust housing. The processed air is exhausted from the tub/drum assembly through the duct into the exhaust housing.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view with the housing in phantom of a combination washer/dryer.

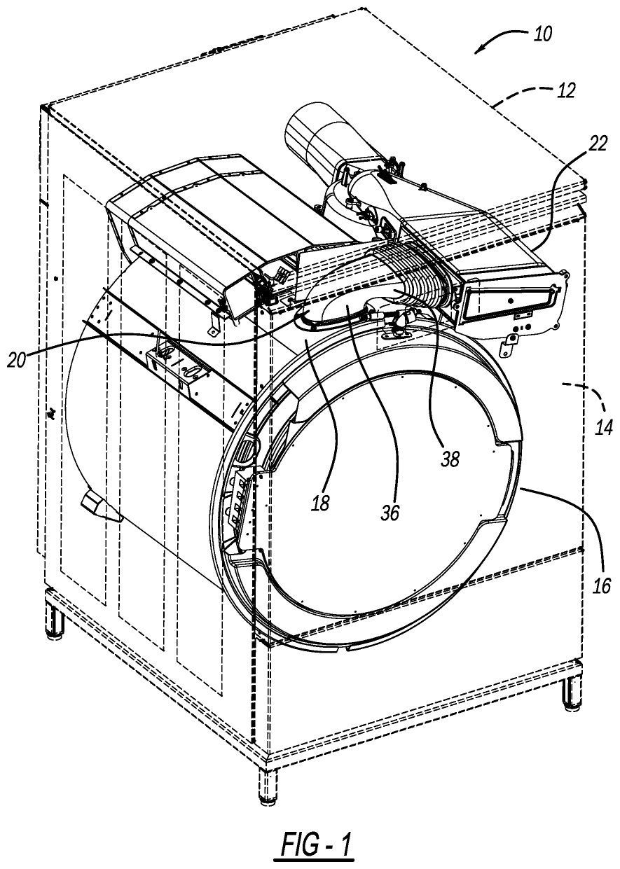

FIG. 2 is a cross-section view of FIG. 1.

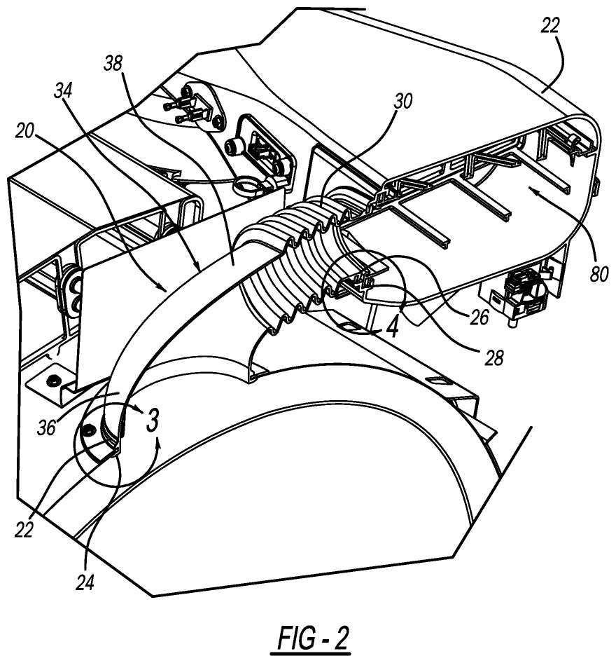

FIG. 3 is an enlarged perspective partially cross-section of FIG. 2.

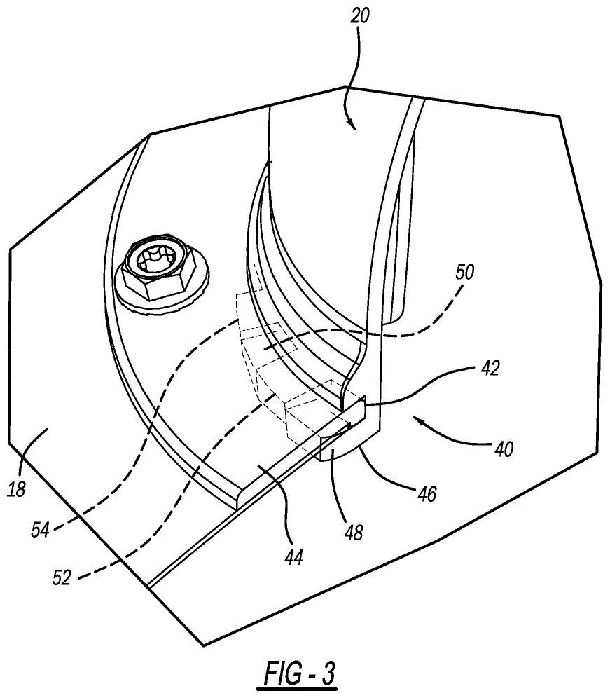

FIG. 4 is an enlarged perspective partially cross-section of FIG. 2.

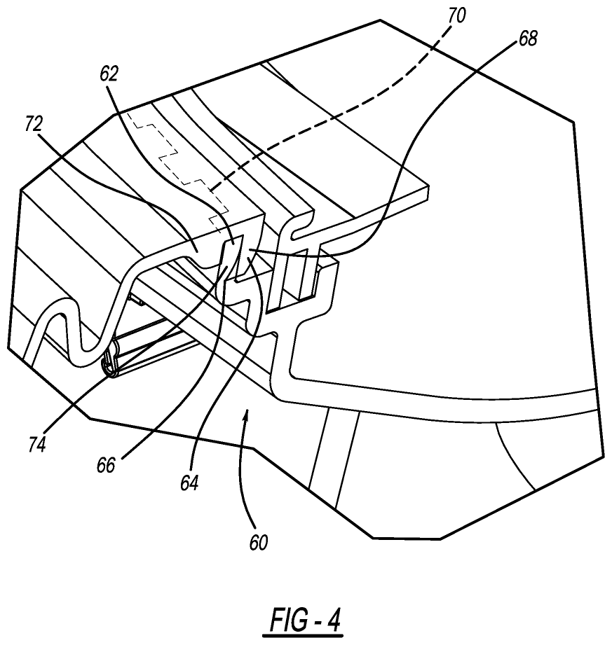

FIG. 5 is a perspective view partially in cross-section of a second embodiment of a duct.

FIG. 6 is an exploded perspective view of FIG. 5

### DETAILED DESCRIPTION

Turning to the figures, an appliance such as a combination washer/dryer machine is illustrated and designated with the reference numeral 10. The combination washer/dryer 10 includes a housing or cabinet 12 with a door 14 enabling access into the tub/drum assembly 16. The tub/drum assembly 16 includes a duct 20 to transfer processed air from the tub/drum assembly 16 into an exhaust housing 22.

The duct 20 includes an inlet end 22 connected with a tub exhaust outlet 24. The duct outlet end 26 is connected to an inlet 28 of the exhaust housing 22. The duct 20 is flexible and generally manufactured from an elastomeric material. The duct 20 includes a first bellows 30 positioned adjacent the outlet 26. The duct 20 include a body 34 that is of a hollow conduit construction with a substantially constant diameter portion 36, forming a cylinder, exiting from the inlet 22. A tapered conduit section 38 extends to the bellows 30 that is coupled with the exhaust housing 28. The outward taper enables the air to exit the tub 18 and move into the exhaust housing 28.

The inlet 22 includes an attachment portion 40 to enable securement of the duct 20 with the tub 18. The attachment portion 40 includes a groove 42 for receiving a collar 44. The collar 44 is fastened to the tub 18 to maintain the inlet end 22 in contact with the tub 18. A flange 46 defines one end of the groove 42. The flange 46 includes a plurality of peaks and valleys 48, 50 that extend around the periphery of the flange 42. Likewise, the collar 44 is ring shaped and has a complementary plurality of peaks and valleys 52, 54 that correspond to the peaks and valleys 48, 50 of the flange 42 to provide an interlocking connection between the two. Thus, a tongue and groove connection is provided by the peaks and valleys (48, 50 and 52, 54) to secure the duct inlet 22 with the collar 44 which, in turn, is coupled with the tub 18.

The duct outlet end 26 includes an attachment mechanism 60. The attachment mechanism 60 includes a groove 62 and a flange 64. The groove 62 enables a flange 66 of the exhaust housing 22 to be positioned into the groove 62. The duct flange 64 has a plurality of peaks 68 and valleys 70 provided about its periphery to engage with a plurality of peaks 72 and valleys 74 in the exhaust flange 66. Thus, the duct outlet 26 is interlocked with the exhaust housing 22. This tongue and groove arrangement provides the interlocking between the two so that a strong securement is provided between the duct 20 and exhaust housing 22. The exhaust housing 22 may include a lint collector 80 provided along the air flow path aligned with the flexible duct 20. Thus, as the air exits the tub 18, it is directed into the exhaust housing 22 and through the lint collector 80.

Thus, the bellows 30 provide the compressive and expansive movement of the duct 20 in response to movement of the tub/drum assembly 16 during the washing and drying cycles. Also, the flexible duct 20 withstands the heat during the drying cycle while providing movement to enable a connection between the dynamic tub/drum assembly 16 and the static exhaust housing 22. Additionally, the flexible duct 20 compensates for vibration during the movement of the tub/drum assembly 16 during the washing and drying cycles. The tongue and groove connections at the inlet end 24 and outlet end 26 maintain a positive connection between the flexible duct 20 with the tub 18 and the exhaust housing 22, respectively.

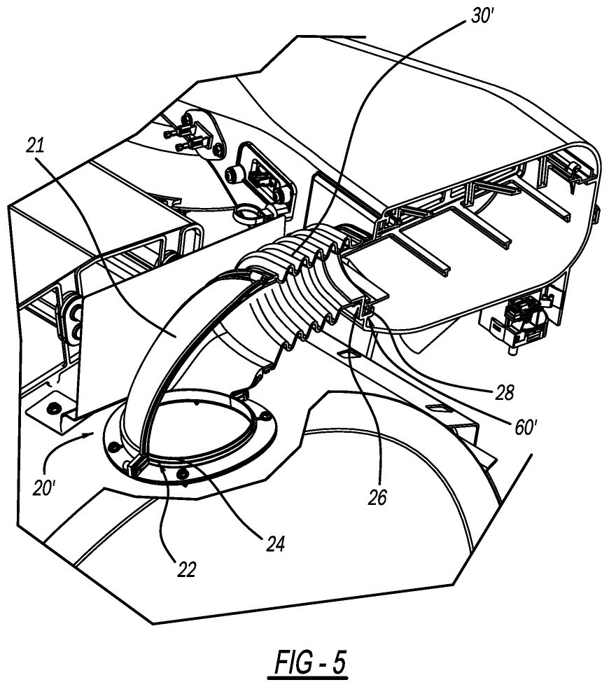

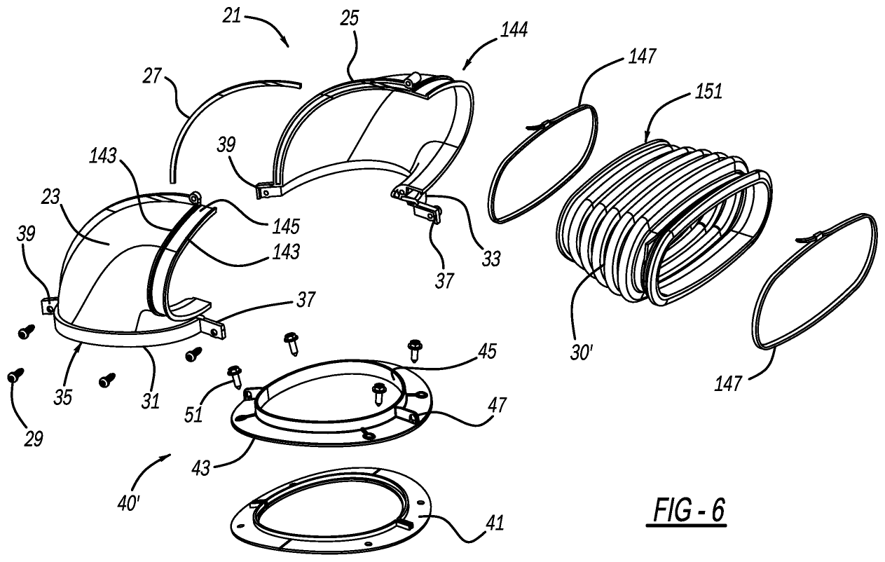

Turning to FIGS. 5 and 6, a second embodiment of the duct is shown. The elements that are the same will be identified with the same reference numbers. The difference is that the duct can be a two piece duct.

The duct 20′ is a two piece duct with a duct portion 21 and bellows 30′. The duct portion 21 includes an inlet end 22 connected with a tub exhaust outlet 24. The duct portion 21 may be flexible or rigid and generally manufactured from plastic material. The bellows 30′ includes the outlet 26.

The duct portion 21 is of a two piece construction including halves 23, 25 connected together. A seal 27 is positioned between the two halves and secured in position by fastener 29. Additionally, the halves 23, 25 having connecting portions 31, 33 that form a ring 35. Flanges 37, 39 extend from the connecting portions 31, 33 to secure with the tub. The two halves 23, 25 also include a bellows receiving portion 144 that is U-shaped with legs 143 and web 145. The bellows end 151 is positioned over one of the legs 143 and seats in the web 145. A clamp 147 is positioned over the bellows 30 to retain it onto the duct portion. The duct portion 21 is of a hollow conduit construction with cylinder portions 36 exiting from the inlet portion. A tapered section 38 extends from the cylinder portion to couple with the bellows 30. The outward taper enables the air to exit the tub 18 and move into the exhaust housing 28.

The attachment member 40′ enable securement of the duct portion 21 with the tub 18. The attachment member 40′ includes a seal 41 and collar 43. The seal 41 is placed on the tub 18 and includes apertures to receive fasteners. The collar 43 includes flange 45 that extends into the ring 35. The flange 45 has extensions 47 that are positioned between flanges 37 and 39 to secure the collar 43 with the duct portion 21. Likewise, the collar 43 is ring shaped with a plurality of apertures to receive fasteners 51 to secure the collar 43, seals 41 and duct portion 21 with the tub 18.

The exhaust housing 22 may include an attachment mechanism 60′ like the bellows receiving portion 144 on the duct portion 21. Thus, the bellows would fit over the attachment mechanism 60′ and be secured by a clamp 147. Also, the bellows 30 and housing could have the tongue and groove arrangement between the bellows 30 and exhaust housing 22 as previously described.

Thus, the bellows 30 provide the compressive and expansive movement of the duct 20′ in response to movement of the tub/drum assembly 16 during the washing and drying cycles. Also, the flexible duct 20′ withstands the heat during the drying cycle while providing movement to enable a connection between the dynamic tub/drum assembly 16 and the static exhaust housing 22. Additionally, the flexible duct 20′ compensates for vibration during the movement of the tub/drum assembly 16 during the washing and drying cycles. The connections at the inlet end 24 and outlet end 26 maintain a positive connection between the flexible duct 20 with the tub 18 and the exhaust housing 22, respectively.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A mechanism for transferring processed air in an appliance, such as a dryer or washer/dryer combo or the like, between a tub/drum assembly and an exhaust housing comprising:
a duct having an inlet end and an outlet end, the inlet end for connecting to the tub/drum assembly and the outlet end for connecting to an exhaust housing;
a compressing and expanding member positioned between the inlet end and the outlet end, the mechanism compressing and/or expanding with movement of the tub/drum assembly during washing and/or drying cycles of the appliance; and
at least one of the inlet and outlet ends includes a retaining member for securing the duct with the tub/drum assembly or the exhaust housing.

2. A mechanism according to claim 1, wherein the compressing and expanding mechanism includes at least one bellows in the duct for enabling movement of the duct in response to tub/drum assembly movement.

3. The mechanism according to claim 2, wherein the bellows is adjacent the outlet end.

4. The mechanism according to claim 1, wherein the retainer member is interlocking and includes a tongue and groove assembly securing the at least one end.

5. The mechanism according to claim 4, wherein the tongue and groove assembly is positioned at both the inlet and outlet ends.

6. The mechanism according to claim 5, wherein the inlet end tongue and groove assembly includes an annular flange with peaks and valleys meshing with corresponding peaks and valleys of an annular collar that is to be secured to the tub/drum assembly.

7. The mechanism according to claim 5, wherein the outlet end tongue and groove assembly includes a flange on the exhaust housing with peaks and valleys meshing with corresponding peaks and valleys in the duct outlet.

8. A combination washer/dryer comprising:
a housing unit or cabinet;
a tub /drum assembly positioned inside the housing unit, the tub/drum assembly including an exhaust outlet;
a duct having an inlet end and an outlet end, the inlet end connected to the tub/drum exhaust outlet and the outlet end connected to an exhaust housing;
a compressing and expanding member positioned between the inlet end and the outlet end, the mechanism compressing and expanding with movement of the tub/drum, assembly during washing and/or drying cycles; and
at least one of the inlet and outlet ends includes a retaining member for securing the duct with the tub/drum assembly or the exhaust housing.

9. The combination washer/dryer according to claim 8, wherein the compressing and expanding mechanism includes at least one bellows in the duct for enabling movement of the duct in response to tub/drum assembly movement.

10. The combination washer/dryer according to claim 9, wherein the bellows is adjacent the outlet end.

11. The combination washer/dryer according to claim 8, wherein the retainer member is interlocking and includes a tongue and groove assembly securing the at least one end.

12. The combination washer/dryer according to claim 11, wherein the tongue and groove assembly is positioned at both the inlet and outlet ends.

13. The combination washer/dryer according to claim 12, wherein the inlet end tongue and groove assembly includes an annular flange with peaks and valleys meshing with corresponding peaks and valleys of an annular collar is to be secured to the drum/tub assembly.

14. The combination washer/dryer according to claim 12, wherein the outlet end tongue and groove assembly includes a flange on the exhaust housing with peaks and valleys meshing with corresponding peaks and valleys in the duct outlet.

15. A method of transferring processed air in a combo washer/dryer unit comprising the steps of:
providing a housing unit or cabinet and a tub/drum assembly positioned inside the housing unit, the tub/drum assembly including an exhaust outlet;
securing a duct, with an inlet end and an outlet end, to the tub/drum assembly and the exhaust housing;
compressing and/or expanding the flexible duct in response to movement of the tub/drum assembly during washing and/or drying cycles;
securing at least one of the inlet and outlet ends with a retaining member to tub/drum assembly or the exhaust housing; and
passing processed air from the tub/drum assembly through the duct to the exhaust housing.

16. The mechanism of claim 1, wherein the duct is a two piece duct with a duct portion and a bellows secured to the duct portion.

17. The mechanism of claim 16, wherein the duct portion includes two halves secured with one another and a connection member securing with a collar for securing the duct portion to the tub.

18. The mechanism of claim 16, wherein the duct portion includes a receiving portion for receiving the compressing and expanding member and a clamp for maintaining the compressing and expanding member on the duct portion.

19. The combination washer/dryer of claim 8, wherein the duct is a two piece duct with a duct portion and a bellows secured to the duct.

20. The combination washer/dryer of claim 19, wherein the duct portion includes two halves secured with one another and a connection member securing with a collar for securing the duct portion to the tub.
